(19) United States
(12) Patent Application Publication
(10) Pub. No.: US 2022/0049066 A1
(43) Pub. Date: Feb. 17, 2022

(54) Ultraviolet Inhibiting Stretch Film

(71) Applicant: Paragon Films, Inc., Broken Arrow, OK (US)

(72) Inventor: Tom Roudebush, Broken Arrow, OK (US)

(73) Assignee: Paragon Films, Inc., Broken Arrow, OK (US)

(21) Appl. No.: 17/461,203

(22) Filed: Aug. 30, 2021

Related U.S. Application Data
(63) Continuation of application No. 17/150,855, filed on Jan. 15, 2021, now abandoned.
Application No. 17/150,855 is a continuation of application No. 16/895,581, filed on Jun. 8, 2020, now abandoned.
(60) Provisional application No. 62/858,044, filed on Jun. 6, 2019.

(51) Int. Cl. C08K 5/17

(52) U.S. Cl. CPC C08K 5/17

(57) ABSTRACT

According to one aspect of the invention, a five-layer stretch film is fabricated using UVI hindered amine light stabilizers additives in a dispersal percentage of around 4% or less. According to a second aspect, the additive dispersal percentage is around 2.8% or less. According to further aspects, the additives are included in interior layers but not in a core layer or skin layer. For example, in a five-layer film in which the layers are arbitrarily identified as A-E, wherein layers A and E are the skin layers, the additive is added into layers B and D but not others. In this manner, the thermal degradation problems associated with untreated film are avoided or minimized, while the integrity of the core layer and the cling of the skin layer are not affected.

### TECHNICAL FIELD

The present invention relates generally to methods and means of manufacturing and using ultraviolet radiation resistant stretch films, and in a particular though non-limiting embodiment to an ultraviolet light inhibitor that protects stretch films from radiation exposure such as sunlight, thereby preventing or delaying associated structural degradation and extending the lifespan of stretch film exposed to such radiation.

### BACKGROUND

Stretch films are widely used in a variety of bundling and packaging applications. For example, machine and hand stretch films are a common means for securing bulky loads such as boxes, merchandise, produce, equipment, parts, and other similar items on pallets.

After loads are wrapped with stretch film, they are placed onto trucks, trains, ships, and the like for transportation. Wrapped pallets and other wrapped loads are placed next to each other during transportation, with the outside layers of the stretch film ultimately securing the loads. Unfortunately, this process can result in pallet-to-pallet distortion and product abuse that is further exacerbated by film degradation due to ultraviolet radiation exposure such as sunlight.

Ultraviolet radiation, typically defined as light disposed in an electromagnetic spectral band having wavelengths of between around 10 nm and around 400 nm (in other words, shorter than the wavelengths of visible light but longer than X-rays) degrades stretch wrap film at the molecular level, causing polymer chain bonds to weaken, break apart, and ultimately disintegrate. It is therefore known in the prior art to add ultraviolet light stabilizing additives to stretch film chemical compositions in order to stave off such deleterious effects.

One previously known class of ultraviolet inhibitors (“UVI”) are known as hindered amine light stabilizers (or “HALS”), the use of which is drawn to encouraging degradation of the HALS rather than the film polymers, thereby extending shelf life and commercial usefulness.

Some HALS, for example UV Masterbatch™ by Ingenia Polymers™, include ultraviolet light stabilizing compounds further comprising antioxidants disposed in an LLDPE carrier resin.

HALS-class stabilizers regenerate to some extent, which suggests the possibility of improved, long-lasting ultraviolet stabilization. Known antioxidant compounds include blends of phenol, phosphate and lactone based antioxidants, which can provide both better processing characteristics and long-term thermal stability.

The specific gravity of such additives is typically less than the specific gravity of water, so the additives are easily blended into either proprietary or openly published mixtures of existing stretch film compositions and are generally useful in connection with LDPE, LLDPE and HDPE cast, blown and extrusion coated film extrusions.

As an aside, ordinarily skilled artisans will appreciate that such stabilizers can be subject to restriction under Title 21 of the Code of Federal Regulations, and care should be taken when considering manufacture of polymers intended for use in contact with food substances and other organic matter.

Another HALS known in the industry branded as Tinuvin™ is manufactured by BASF™. Tinuvin is a well-known HALS used for a broad base of commercial applications, and in particular those that call for a low volatility UVI having minimal molecular migration as a result of an oligomeric structure having a high molecular weight.

Tinuvin can also be used as an antioxidant that contributes to the long-term heat stability of polyolefins and tacking resins. In addition to polyolefins such as polypropylene and polyethylene, Tinuvin is also marketed in connection for use with olefin co-polymers such as EVA, as well as blends of polypropylenes and elastomers. Tinuvin is also believed useful in connection with polyacetals, polyamides and polyurethane applications.

Yet another known stabilizer branded as Chimassorb™ is also manufactured by BASF™. Chimassorb is a high molecular weight hindered amine light stabilizer exhibiting high extraction resistance and low volatility, and has been found useful as a long-term thermal stabilizer in thin articles of manufacture such as fibers and films, and has a thick cross section especially beneficial in the stabilization of polyethylenes.

Consequently, the foregoing products are regularly used in the stretch film industry. However, certain beneficial properties can also be lost using UVI additives.

For example, while HALS type UVI are widely used in the stretch film industry as an additive to resist UV degradation, current industry practices call for global dispersal of the additive in all layers of the film. This practice, however, causes degradation of desirable film properties due to the inherently reactive nature of the UVI chemistry.

For example, The HALS UVI from Ingenia™ discussed in the background of this disclosure (which also appears to contain unspecified ratios of Tinuvin™ and Chimassorb™) loses many of its beneficial properties when globally dispersed across all layers, such as a loss of cling in the skin layer, a loss of structural integrity and durability in the core layer, etc.

There is, therefore, a longstanding but unmet need for stretch films manufactured using currently known or future devised HALS type UVI additives (or combinations thereof) while avoiding the deleterious effects present in the prior art.

### SUMMARY

According to one example embodiment, a five-layer stretch film is fabricated using known UVI HALS additives similar in composition, or at minimum similar in efficacy, to those described earlier in this disclosure in dispersal percentage of around 4% or less. In a particular though non-limiting embodiment the additive dispersal percentage is around 2.8% or less.

In a further embodiment the additives are included in interior layers but not in the core layer or skin layer. For example, in a five-layer film in which the layers are arbitrarily identified as A-E, wherein layers A and E are the skin layers, the additive is added into layers B and D but no others.

In this manner, the thermal degradation problems associated with untreated film are avoided or minimized, while the integrity of the core layer and the cling of the skin layer are not affected.

In a further example embodiment wherein a seven-layer film comprises skin layers A and G and a core layer D, the UVI HALS are added to layers B, C, E and F for reasons similar to those discussed above. In a still further example embodiment, maximum protection for the composition as a whole is realized in applications where reduced cling is desirable and the HALS are also added to the skin layer, for example, in applications where loads are wrapped very tightly but noise reduction attributable to agitation of film between and amongst neighboring pallets, as the HALS itself can be used to both block UV radiation and reduce cling.

In more complex examples of films having multivariable layers, addition of UVI HALS to different interior layers, but excluding the skin and core layers, are used to acquire the specific properties dictated by the application, with relevant factors typically including, at minimum, ultraviolet radiation degradation reduction, the desirability of high cling in the skin layer, and high core level structural integrity.

In general, by not including the HALS UVI additives in the skin layer, the most desirable skin layers properties, especially cling, are unaffected. Another benefit is that the polypropylene layer(s) will retain strength offline without the addition of polyethylene based HALS, as polypropylene is less affected when disposed in the core of the film.

Ordinarily skilled artisans in the appropriate arts will readily appreciate that a theoretically limitless number of combinations, film layer selections for addition and withholding of UVI additive, and stretch film composition characteristics during both processing and afterward, are possible by systematically varying the skin layer addition of the UVI HALS and, in general, avoiding the core and skin layers so that the principal properties of the resulting film are preserved and deleterious effects are minimized.

The foregoing specification is provided only for illustrative purposes, and is not intended to describe all possible aspects of the present invention. While the invention has herein been shown and described in detail with respect to several exemplary embodiments, those of ordinary skill in the art will appreciate that minor changes to the description, and various other modifications, omissions and additions may also be made without departing from the spirit or scope thereof.

1. An ultraviolet radiation resistant stretch films comprising an ultraviolet light inhibitor, wherein said ultralight inhibitor protects stretch films from radiation exposure, thereby preventing or delaying associated structural degradation and extending the lifespan of stretch film exposed to such radiation.
